(19) United States
(12) Patent Application Publication
(10) Pub. No.: US 2023/0419702 A1
(43) Pub. Date: Dec. 28, 2023

(54) SYSTEM, METHOD AND APPARATUS FOR PRICE LABEL MODELING TOOL

(71) Applicant: Omni Consumer Products, LLC, Addison, TX (US)

(72) Inventors: Robert Reynolds, Addison, TX (US); Ovunc Tuzel, Addison, TX (US); Marc A. Gilpin, Richardson, TX (US)

(73) Assignee: Omni Consumer Products, LLC, Addison, TX (US)

(21) Appl. No.: 18/253,182

(22) PCT Filed: Nov. 19, 2021
(86) PCT No.: PCT/US2021/060172

§ 371 Date: May 16, 2023

Related U.S. Application Data
(60) Provisional application No. 63/116,565, filed on Nov. 20, 2020.

(51) Int. Cl. G06V 30/224; G06V 30/14; G06V 10/56; G06V 10/75

(52) U.S. Cl. CPC G06V 30/224; G06V 30/1444; G06V 10/56; G06V 10/751

(57) ABSTRACT

Methods for label detection are disclosed herein. The method includes receiving, by a processor, an image of a label, detecting, by the processor, one or more physical characteristics of the label, determining, by the processor, one or more colors of the label, determining, by the processor, a data identifier for the one or more colors of the label, determining, by the processor, a product identifier associated with the label based on the data identifier, and generating, by the processor, a signal indicating a product to a user based on the product identifier

### CROSS REFERENCE TO RELATED APPLICATIONS

The disclosure claims priority to and benefit of U.S. Provisional Patent Application No. 63/116,565, filed Nov. 20, 2020, the entire disclosure of which is hereby incorporated by reference herein.

### FIELD OF THE INVENTION

The disclosure relates to systems, apparatus and methods for modeling a price label using computer vision. More specifically, this disclosure relates to detecting and locating one or more price labels in an aisle.

### BACKGROUND OF THE INVENTION

Currently, businesses utilize human services to support pricing and labeling services, including determining whether a price tag is accurate and placed at the right location. As such, the accuracy levels are below 60% and are determined to be costly for businesses and, at times, misleading to customers. Hence, there is a need for a way to determine that a price label is accurate and placed in the right location.

### SUMMARY OF THE INVENTION

The systems, methods, and devices of this disclosure each have several innovative aspects, no single one of which is solely responsible for all of the desirable attributes disclosed herein. Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

In accordance with some embodiments of the present disclosure, a system is disclosed. The system includes a processing circuit comprising one or more memory devices coupled to one or more processors, the one or more memory devices configured to store instructions. When executed by the one or more processors, the instructions cause the processing circuit to receive an image of a label, detect one or more physical characteristics of the label, determine one or more colors of the label, determine a data identifier for the one or more colors of the label, determine a product identifier associated with the label based on the data identifier, and generate a signal indicative of the product identifier.

In accordance with some embodiments of the present disclose, a method is closed. The method includes receiving, by a processor, an image of a label, detecting, by the processor, one or more physical characteristics of the label, determining, by the processor, one or more colors of the label, determining, by the processor, a data identifier for the one or more colors of the label, determining, by the processor, a product identifier associated with the label based on the data identifier, and generating, by the processor, a signal indicative of a product corresponding to the product identifier.

In accordance with some embodiments of the present disclosure, a system is disclosed. The system includes a processing circuit comprising one or more memory devices coupled to one or more processors, the one or more memory devices configured to store instructions. When executed by the one or more processors, the instructions cause the processing circuit to receive an image of one or more labels within an aisle, determine a coordinate location for each of the one or more labels in the image, receive a video of the aisle, compare the image of the one or more labels within the aisle with the video of the aisle to determine a highest value of feature matching, determine a transformed coordinate location for each of the one or more labels based on the comparison of the image of the one or more labels within the aisle with the video of the aisle, and determine a location for each of the one or more labels in the aisle based on the transformed coordinate location.

The foregoing summary is illustrative only and is not intended to be in any way limiting. In addition to the illustrative aspects, embodiments, and features described above, further aspects, embodiments, and features may become apparent by reference to the following drawings and the detailed description.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is an example flowchart outlining operations of a process for a label detection method, according to an exemplary embodiment.

FIG. 2 is a diagram illustrating a process for image refinement, according to an exemplary embodiment.

FIG. 3 is a diagram illustrating a process for label refinement, according to an exemplary embodiment.

FIG. 4 is a diagram illustrating a fiducial label or marker, according to an exemplary embodiment.

FIG. 5 is an example flowchart outlining operation of a process for a label localization method, according to an exemplary embodiment.

FIG. 6 is a diagram illustrating an embodiment of feature detection between a still image and a sequence of frames or video, according to an exemplary embodiment.

FIG. 7 is a diagram illustrating re-generated product label, according to exemplary embodiment.

FIG. 8 is an example flowchart outlining operations of a process for a color correction method, according to an exemplary embodiment.

FIG. 9 is a diagram illustrating a label mapping apparatus, according to an exemplary embodiment.

FIG. 10 is a diagram illustrating a label mapping system, according to an exemplary embodiment.

### DETAILED DESCRIPTION

Embodiments described herein relate to a system, method, and apparatus for label detection and label localization. The label mapping system may include a processor, memory, a detection module, and a localization module. The detection module may facilitate the label detection method as described in more detail below. The localization module may facilitate the label localization method as described in more detail below.

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Aspects of the present disclosure are described herein with reference to flowchart illustrations and/or block diagrams of methods, systems and computer program products according to embodiments of the disclosure. It will be understood that each block of the flowchart illustrations and/or block diagrams, and combinations of blocks in the flowchart illustrations and/or block diagrams, can be implemented by computer program instructions, hardware or a combination thereof. It is also understood that not all the elements listed are required and that the order specified is only by way of example.

Embodiments of the systems, methods, and apparatuses described herein may provide one or more benefits include for example: 1) automating the label detection and label mapping process thereby reducing the amount of time and resources dedicated to detecting and mapping labels; 2) reducing the risk of human error in the label detection and label mapping process; and 3) increased accuracy in product labeling.

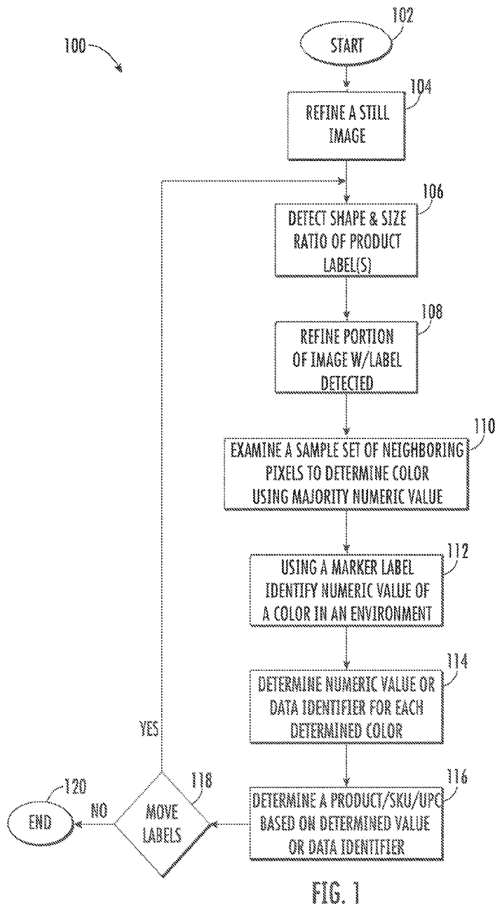

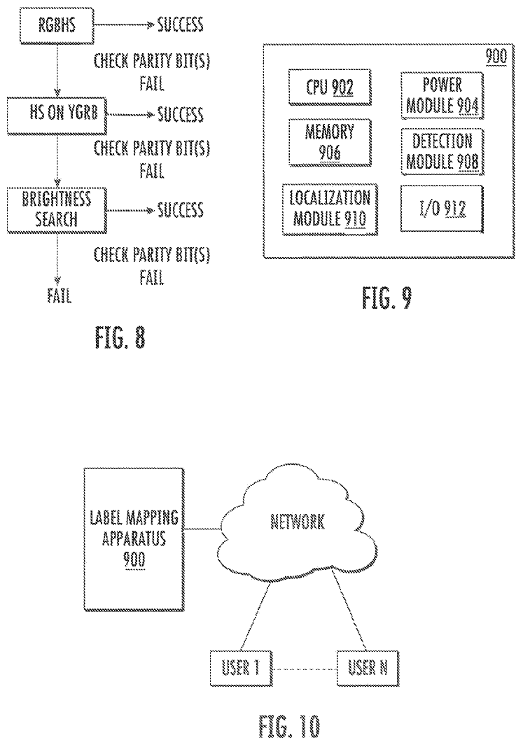

FIG. 1 is an example flowchart outlining operations of a process for a label detection method 100. The label detection method 100 may be implemented by a detection module 908 of a label mapping apparatus 900 which is described in more details below with respect to FIG. 9. The method 100 may be used to detect and identify a product label within an image. For example, the method 100 may be used to detect a label within a retail context (e.g., such as a labels located on retail shelves). Label detection and identification may be important in retail context for ensuring proper placement of product within a retail environment. Therefore a method for detecting and identifying a product label may be desired. In some embodiments, users (e.g., retail workers) may detect and identify a product label manually by physically travelling to the location of the label and identifying the label by a label identifier (e.g., product name, product number, product picture, etc.). Detecting and identifying product labels manually may be time consuming, expensive, and prone to human error. Thus a method for automating the product label detection and identification is implemented by label detection module 908 as described in the following paragraphs.

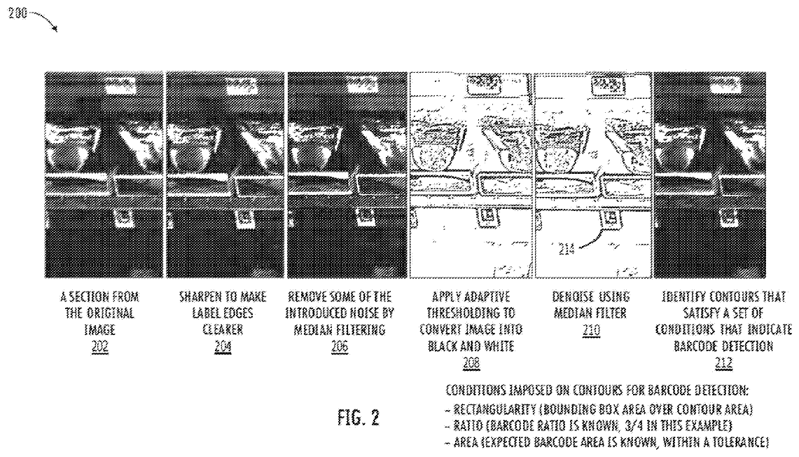

The method 100 starts at step 102 by receiving an image of a label. In some embodiments, the label detection module 908 may receive the image of the label from an external source (e.g., camera, computer, mobile device, storage device, etc.). For example, cameras may be placed at various locations in a retail environment which capture one or more images of a label which may then be sent to and received by the label detection module 908. Given that the cameras often used in a retail environment do not usually have the highest resolution, the images received by the label detection module 908 may not have the clarity necessary to properly detect and identify the label. Thus the image of the label received by the label detection module 908 may be refined before proceeding with the remainder of the method 100. At step 104, an image is refined for the sake of clarity. For example, the image of the label may be refined (e.g., filtered, enhanced, etc.) to be less blurry, have sharper edges, have less noise, etc. The process for refining the image of the label is described in more detail below with respect to FIG. 2.

After the image of the product label has been refined, the method 100 proceeds to step 106. At step 106, the label detection module 908 detects the shape and size ratio of the product label. More specifically, the image of the label received at step 102 may include extra objects outside of the product label (e.g., shelving unit, retail signage, retail products, etc.). At step 106, the label detection module 908 detects the shape and size ratio of the product label to determine which part of the image to focus on for detecting and identifying the product label. In some embodiments, the label detection module 908 may crop the image of the product label to only include the product label based on the shape and size ratio of the product label detected at step 106.

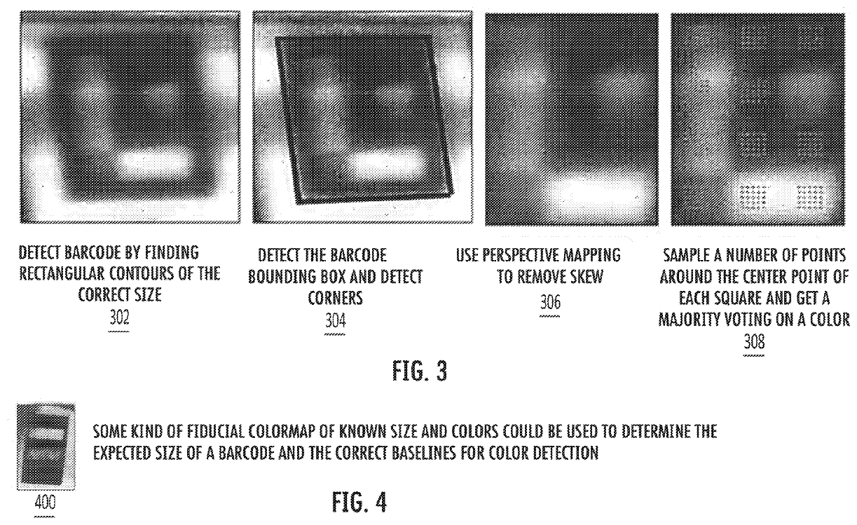

After the shape and size ratio of the product label has been detected, the method 100 proceeds to step 108. At step 108, the label detection module 908 refines the label(s) detected at step 106 to ensure that the format or shape of the production label has enough clarity for color detection. Similar to step 104, the image of the detected label may not have enough clarity for determining the identity of the product label and may need refining. The process for refining the detected product label is described in more detail below with regards to FIG. 3.

At step 110, the label detection module 908 examines a sample set of pixels within the detected product label to determine the color of the detected product label. In one embodiment, the color of the product label is determined by the majority value of the sample pixels. The sample set of pixels selected may be neighboring one another in order to determine the color of the area of the sample pixels. The majority value refers to the highest amount of pixels that have the same color in common. For example, if ten pixels are selected as the sample set with seven pixels being grey, one pixel being white, and two pixels being black, the majority value would be seven and the majority color would be grey. In some embodiments, the sample set of pixels may be predefined as a certain number of pixels in a certain location. For example, twenty pixels in the center of the detected product label may be the predefined sample set of pixels. In some embodiments, the label detection module 908 compares the color of the product label determined by the sample set of pixels to a marker or fiducial label to identify a numeric value of the color of the product label, at step 112. The fiducial marker or label may be defined as a reference that defines a physical characteristic (e.g., color, length, size, etc.) of an object when the marker is compared to the object. For example, a ruler may be considered a fiducial marker that defines the length of an object when the ruler is compared to the ruler. In this disclosure, the fiducial marker may include predetermined color samples with predetermined identifiers corresponding to each color sample. For example, fiducial marker 400 shown in FIG. 4 may be used to determine a color of a product label. When comparing the fiducial marker to the color of the product label determined by the sample set of pixels, the color of the product label may be described using the predetermined identifiers corresponding to each color sample. In some embodiments, the predetermined identifiers corresponding to each color sample may be a red-blue-green color code. In some embodiments, the predetermined identifiers corresponding to each color sample may be a hexadecimal code. In some embodiments, the predetermined identifiers corresponding to each color sample may be a cyan-magenta-yellow-black(CMYN) code. In some embodiments, the predetermined identifiers corresponding to each color sample may be a hue-saturation-value (HSV) code. In some embodiments, the predetermined identifiers corresponding to each color sample may be a hue-saturation-lightness (HSL) code. As such the predetermined identifiers corresponding to each color sample in the fiducial marker functions as a guide to determine a numeric value or data identifier for each color determined within the product label at step 114.

Once the label detection module 908 determines the numeric value or data identifiers for each color within the product label, the label detection module 908 determines a product identifier based on the numeric value or the data identifier of the color of the product label. In some embodiments, the product identifier may be a stock keeping unit which is a numeric value that a retailer may assign to product for stock keeping units. In some embodiments, the product identifier may be a universal product code which is a barcode that may be used to identify common products worldwide. Once a product identifier has been determined, a signal may be generated to communicate the product corresponding to the product identifier. For example, some retail environments utilize electronic product labels. In this case, the label detection module 908 may generate a signal that displays the product label displaying a product corresponding product identifier on the electronic product label such that a user may be able to identify a product based on the product identifier.

Once the label detection module 908 determines a product identifier at step 116, the label detection module 908 determines if more labels need to be processed through the method 100. In some embodiments, the image received at 102 and refined at 104 may include more than one label that needs to be identified. In this case, the method 100 may be repeated to determine a product identifier for each product label within the image. If there are more labels that need to be processed (118: YES), then the method repeats as described above starting at step 106. If there are not more label that need to be processed (118: NO), the method 100 ends at step 120.

FIG. 2 is an example flowchart outlining operations of a process 200 for refining the image of the label received at step 104 of label detection method 100. In some embodiments, the process 200 may be implemented by the label detection module 908. As described above, the image of the label received by the label detection module 908 may not have the clarity necessary to properly detect and identify the label. Thus the process 200 for refining the image of the label is implemented by label detection module 908 as described in the following paragraphs.

The process 200 starts at step 202 with the label detection module 908 focusing on a section of the image of the label received. In some embodiments, the label detection module 908 may focus on a section of the image that has a high likelihood of containing a product label. For example, based on the position of a camera and the typical images received, the label detection module 908 may be trained to focus on certain sections of the image that center the label. In some embodiments, artificial intelligence and/or machine learning may be utilized to train the label detection module 908 to recognize sections of images received that include the product label. In other embodiments, the label detection module 908 may partition the image received into separate sections and focus on each of the sections separately at step 202. In this case, the process 200 may be completed for each section of the image received.

The process 200 then proceeds to step 204, with the label detection module 908 sharpening the image of the label received. The image may be sharpened in order to make the edges of the product label clear. The process 200 then proceeds to step 206. At step 206, the label detection module 908 removes some of the noise in the image by median filtering. Median filtering is an image filtering technique in which noise may be removed from an image while preserving the edges of the image.

The process 200 then proceeds to step 208 where the label detection module 908 applies an adaptive thresholding technique to convert the image to black and white. Adaptive thresholding is an image filtering technique in which each pixel within an image is either set to black (e.g., hexadecimal code=#000000) or white (e.g., hexadecimal code=#FFFFFF) based on whether the pixel is above or below a certain threshold value. More specifically, adaptive thresholding dynamical changes the threshold value for each pixel as it is applied over the whole image. This allows the black and white image to have more clarity because adaptive thresholding accounts for various image conditions (e.g., lighting gradient on the image, etc.). The process 200 then proceed to step 210 where the label detection module removes noise from the black and white image using a median filter 210. In some embodiments, step 210 is similar to step 206.

The process 200 then proceeds to step 212 where the label detection module 908 identifies contours that satisfy a set of conditions that indicate barcode detection. In some embodiments, one of the conditions that indicate barcode detection may be identifying a rectangular shape (e.g., a rectangular bounding box over a contour area). For example, the rectangular shape 214 may satisfy this condition. In some embodiments, one of the conditions that indicate barcode detection may identify a predetermined ratio. For example, a particular retail environment may utilize barcodes with a certain ratio (e.g., ¾). In this case, the rectangular shape 214 may satisfy this condition. In some embodiments, one of the conditions that indicate barcode detection may be a certain area associated with a shape. For example, a retail environment may utilize barcodes that have a certain area. In this case, the label detection module 908 may measure the shape to determine whether it fits within a certain area given a tolerance. In this case, the rectangular shape 214 may satisfy this condition. If a shape satisfies each of the conditions previously mentioned, the label detection module may determine that a product label (e.g., a barcode) has been detected within the image. Though the process 200 is described as including steps 202 through 212, in some embodiments, only a subset of the steps may be performed to refine the image of the product label.

FIG. 3 is an example flowchart outlining operations of a process 300 for detecting and identifying colors within a product label. In some embodiments, the process 300 begins following the end of process 200. In some embodiments, the process 300 may be implemented by the label detection module 908. As described above with respect to FIG. 1, image of the detected label may not have enough clarity for determining the identity of the product label and may need refining. Thus the process 300 for refining the image of the detected label is implemented by label detection module 908 as described in the following paragraphs.

The process 300 starts at step 302 with the label detection module 908 detecting the product label by finding a rectangular contour of the correct size. As mentioned above with respect to FIG. 2, the label detection module 908 detects a product label based on the conditions described above (e.g., rectangular shape, correct ratio, and correct size). Then the process 300 proceeds to step 304. At step 304, the label detection module 908 detects the bounding box and corners of the product label. More specifically, the label detection module 908 outlines the product label to separate the product label from the remainder of image. At step 306, the label detection module 908 crops the image based on the bounding box and corners determined at step 304 and uses perspective mapping to remove the skew of the cropped image.

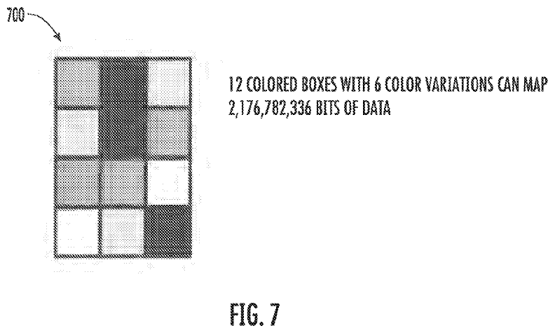

At step 308, the label detection module 908 partitions the detected label into a number of sections and then selects a sample set of pixels within each section that may be used to determine a majority color as described in method 100. For example, the label shown in FIG. 3 is divided into twelve squares. Each of the squares has a sample set of twenty five pixels that may be evaluated to determine the majority color of each square. For example, if twenty out of the twenty five pixels are grey, then the color of that square may be determined to be grey. Once the majority color of each square has been determined, the product label may be regenerated from the image based on the colors of each square determined as explained in method one. For example, product label 700 shown in FIG. 7 may be generated.

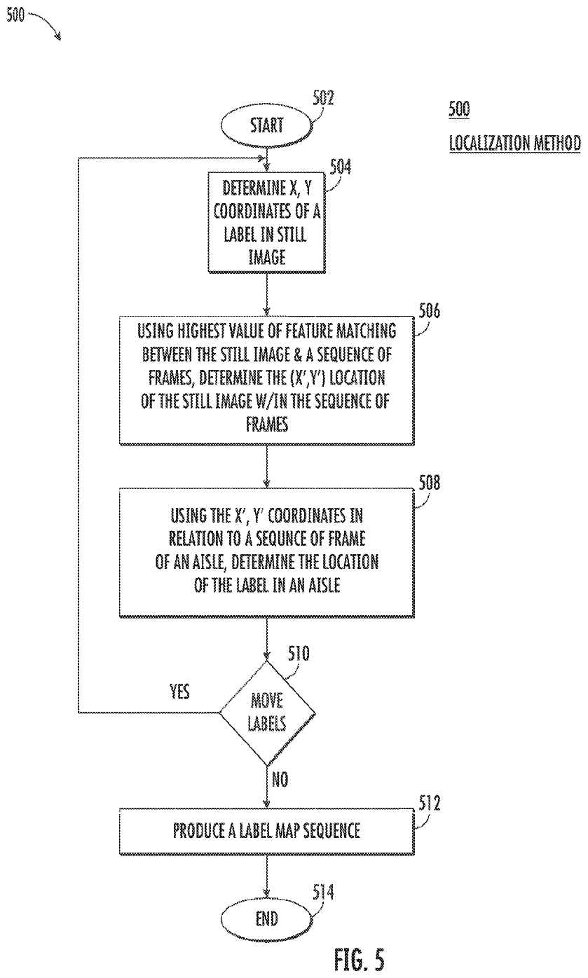

FIG. 5 is an example flowchart outlining operations of a process for a label mapping method 500. The label mapping method may be implemented by a localization module 910 of a label mapping apparatus 900 which is described in more details below with respect to FIG. 9. The method 500 may be used to determine a location of a label within a retail environment and create a map of all the labels within a retail environment in relation to each other. For example, the method 500 may be used to determine one or more labels within an aisle of a store and then create a store map outlining all the aisles and their respective product labels within the store. Label mapping may be important in retail context for ensuring proper placement of product within a retail environment. Therefore a method for creating a label map of a retail environment may be desired. In some embodiments, users (e.g., retail workers) may manually create a label map for a retail environment by manually scanning each label into a system and then arranging the labels in a certain configuration (e.g., by aisle, section, location, etc.). Manually creating a label map of a retail environment may be time consuming, expensive, and prone to human error. Thus a method for automating the label mapping process is implemented by label detection module 908 as described in the following paragraphs.

The method 500 begins at step 502 by receiving an image of a label within an aisle and a video of the aisle in which the label is located. In some embodiments, the label detection module 908 may receive the image of a section of a retail environment (e.g., an aisle, a product display, etc.) from an external source (e.g., camera, computer, mobile device, storage device, etc.). For example, cameras may be placed at various locations in a retail environment which capture one or more images of a retail environment which may then be sent to and received by the localization module 910.

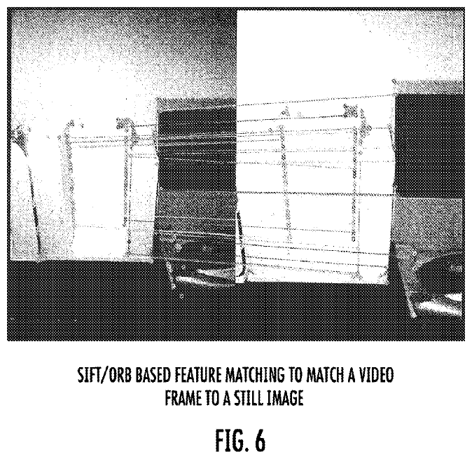

The method 500 then proceeds to step 504 where the localization module 910 determines an X, Y coordinate of a product label in a retail environment section from a single image received at step 502. In some embodiments, the X, Y coordinate of the label is determined by comparing the image of the label to an image of the aisle. At step 506, the localization module 910 compares the highest value from featuring matching between the still image and a sequence of frames (e.g., a plurality of still images or a plurality of frames of a video of the aisle) to determine the transformed coordinates (x′,y′) of the location of the still image within the sequence of frames relative to the sequence of frames, as shown in FIG. 6. FIG. 6 is a diagram illustrating an embodiment of feature detection between a still image and a sequence of frames or video. At step 508, the method 500 uses the transformed coordinates (x′, y′) in relation to the sequence of frames or video to determine the location of the label within the aisle.

At step 510, the localization module 910 determines if the location within an aisle of more labels needs to be determined. If there are more labels that have to be processed (510: YES), then the method repeats as described above starting at step 504. If there are no more labels that have to be processed (510: NO), the method 500 continues to step 512 of the method 500. At step 512, the localization module 910 produces a label map of a retail environment. In some embodiments, the label detection method 100 and the label localization method 500 may be combined to both identify the product label and identify the location of the product label within a retail environment (e.g., determine the location of one or more labels relative to each other within the retail environment). The method 500 ends at step 514.

FIG. 8 is a flow diagram illustrating a process for color correction, for example, via label mapping apparatus. In some embodiments, the color correction process may be included within the label detection method 100. For example, steps 110-114 of the label detection method 100 may include determining the color of a product label. The process for color correction as shown in FIG. 8 may be used to detect a color identification error and after steps 110-114 of the label detection method 100. In one embodiment, a parity bit(s) is utilized for error detection and error correction. For example, in an example where the colored label includes squares with various predetermined colors and each colored square resembles a predetermined numeric value, as shown in FIG. 7, then one of the squares may be used as a parity bit that resembles the addition of the RBG numeric value of all the colors. As such, once a numeric value is determined for all the colored squares, as described in method 100, a check of the parity bit(s) when allow for detecting the error. More specifically, each color may be defined with one or more predetermined identifiers (e.g., a hexadecimal code). The label mapping apparatus may check the hexadecimal code against a parity to detect whether an error has occurred or not.

In some embodiments, an even parity bit may be utilized for error detection. In other embodiments, an odd parity bit may be utilized for error detection. As shown in FIG. 8, the label mapping apparatus may check one or more identifiers of a color against a parity bit to detect an error. For example, in some embodiments, the label mapping apparatus 900 may compare a red-green-blue-horizontal-synchronization (RGBHS) code to either an even or odd parity bit. If no error is detected, then the color may be deemed successfully determined. If an error is detected, then the label mapping apparatus 900 compares red-green-blue-luminance (YGRB) code against either an even or odd parity bit. If no error is detected, then the color may be deemed successfully determined. If an error is detected, then the label mapping apparatus 900 compares the brightness numerical identifier against either an even or odd parity bit. If no error is detected, then the color may be deemed successfully determined. If an error is detected, then the label mapping apparatus 900 determines the color of the product label has not been identified correctly. In one embodiment, the method 100 utilizes RGBHS, YGRB, and/or Brightness search, etc. to attempt to correct the error detected, as shown in FIG. 8.

FIG. 9 is a block diagram illustrating an embodiment of a label mapping apparatus 900. The label modeling apparatus 900 is used to design, present and alter life size space models. The space models may be a life size model of a kitchen, office, yard, etc. The label mapping apparatus 900 comprises a processor (CPU) 902, a power module 904, memory 906, detection module 908, localization module 910, and input/output devices (I/O) 912.

Memory 906 may be any combination of one or more computer readable media. The computer readable media may be a computer readable signal medium, any type of memory or a computer readable non-transitory storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain or store a program for use by or in connection with an instruction execution system, apparatus, or device.

Computer program code for carrying out operations utilizing a processor or CPU 902 for aspects of the present disclosure may be written in any combination of one or more programming languages, markup languages, style sheets and JavaScript libraries, including but not limited to Windows Presentation Foundation (WPF), HTML/CSS, XAML, and JQuery, C, Basic, *Ada, Python, C++, C #, Pascal, *Arduino, JAVA and the likes. Additionally, operations can be carried out using any variety of compiler available.

The computer program instructions on memory 906 may be provided to a processor 902, where the processor 902 is of a general purpose computer, special purpose computer, microchip or any other programmable data processing apparatus to produce a machine, such that the instructions, which execute via the processor of the computer or other programmable instruction execution apparatus, create a mechanism for implementing the functions/acts specified in the flowchart and/or block diagram block or blocks. The computer instructions may do one or more of the following, run the label mapping apparatus 900, give status or health of the label modeling apparatus 900 or the entire system utilizing the label mapping apparatus 900. In one embodiment, it may even perform image analysis and/or perform data compression.

These computer program instructions may also be stored in memory 906 (computer readable medium) that when executed can direct a computer, processor, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, processor, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The power module 904 is utilized to power/maintain power to the label mapping apparatus 900. The power module 904 may be wired or wireless and may utilize one or combination of the following battery, WiFi charging, coil, solar cells, or any other mechanism that provides charge to the label mapping apparatus 900.

The I/O 912 may be any devices that are used to present, print, receive, store, analyze, transmit, communicate, etc. with the label mapping apparatus 900. The I/O 912 may be coupled wirelessly or with a wire with the label mapping apparatus 900.

The processor 902 is coupled to the detection module 908 and the localization module 910 to produce a label mapping using the I/O 912. The detection module 908 includes the label detection method described in FIG. 1. In some embodiments, the detection module 908 may include an image capture device (e.g., camera, video recorder, etc.). The image capture device may capture images that may be processed by the detection module 908 according the label detection method 100 as described above. The localization module 910 includes the label localization method 500 described in FIG. 5. In some embodiments, the localization module 910 may include an image capture device (e.g., camera, video recorder, etc.). The image capture device may capture images that may be processed by the localization module 910 according to the localization method 500 as described above. The detection module 908 and localization module 910 are coupled to produce a label map. The label map is then utilized to determine if labels are in the correct place, products are associated with the right label, accurate information is reflected on the right label in the right place, etc. As such, a retailer, for example, is capable of increasing efficiency, minimizing cost related to inaccurate information and translating the benefit to actual financial benefits.

FIG. 10 is a diagram illustrating an embodiment of a label mapping system. The label mapping system includes a network that facilitate communication between the label mapping apparatus 900 and users 1 . . . N of the label mapping system. In some embodiments the network may be at least one of a WiFi network, a Bluetooth network, a cellular network, etc.

Further embodiment of the label detection and localization methods. The input to the Depth Estimator is a video file in which depth of the objects is to be estimated. The video file is read and each frame is grabbed from the file. Each frame is then processed or updated to compute the depth mask. Optical flow, which is a measure of motion of the objects in the frame, is calculated for each frame starting at second frame using Gunnar-Farneback optical flow algorithm. Gunnar-Farneback optical flow algorithm calculates the flow between the current and the previous frame for each pixel location. The calculated flow gives a measure of how much each pixel in the current frame has moved with respect to the previous frame. The logic behind using the optical flow to estimate the depth is the consideration that objects or locations closer to the camera will move slower and thus will have a smaller flow value as compared to the farther objects. So, the areas with lower flow can be considered as having low depth and areas with high flow can be said to have high depth values. The optical flow calculated for each frame gives a raw flow-based depth map of the frame.

A binary mask is computed from the depth map by doing some thresholding as follows: a. Horizontal component from the depth is taken and vertical component is discarded as the motion of the frames in the video is horizontal and thus the flow for most part of the video is in the horizontal direction. b. For each row in the depth map, a dynamic threshold based on products is calculated by using the product position and depth factor information from product report obtained from the product tracker. For cases where no products are detected around a row of pixels, the threshold is calculated based on the histogram of the depth map. c. Depth of each product whose position is within some tolerance from the current row is taken for each row in the depth map and the threshold for the row is set to the average of the depth of each product. d. If no products are found within some margin of the current row, a different histogram-based threshold is used for the entire row. e. In histogram-based threshold calculation, a histogram is calculated from the depth map/flow map. Histogram is useful to get an estimate of number of total samples having a certain flow value from the depth/flow map. First local minimum, which is the flow value having lowest number of samples among adjacent flow values is calculated from the histogram. All the flow values below the first local minima are ignored since they generally contribute to black pixels or higher depth values. f Threshold is established as a percentile of the non-zero depth samples above the first local minima. g. In case the histogram does not have a local minimum, mean of the entire histogram is taken and used as a frame threshold. This threshold is used when the intelligent threshold mentioned above does not exist for a row. h. Relative depth is calculated for each pixel in the depth map and the final mask is computed by using the above calculated threshold and relative depth for each pixel. The pixels whose relative depth is in some margin of the threshold value of the corresponding row are considered to be white or having low depth and others are considered to be black or having high depth value.

Morphological operations of opening and closing are performed on the computed mask to eliminate the noise from the mask. The final mask gives an estimate of the depth of the areas in the images in form of a binary mask where white pixels have a lower depth value than the black pixels. The mask computed for each frame in the video is then stitched together to form a mask for the complete aisle. Mask stitching is done by using the frame distances to get the measure of the current frame movement with respect to the previous frame. A slice corresponding to the distance the frame has moved is grabbed from the frame and stitched to the previous slice. Temporal filtering is done on this slice before stitching it by applying a gaussian filter on the slices of the neighborhood frames and grabbing the slice of the current frame from the filtered output. Temporal filtering helps in eliminating the noise that is encountered in calculating the depth mask. The filtered slice is then stitched to the previous slice to create a mask for the aisle. The stitched mask is serialized and returned as the output.

It will be appreciated by those skilled in the art that changes could be made to the embodiments described above without departing from the broad inventive concept. It is understood, therefore, that this disclosure is not limited to the particular embodiments herein, but it is intended to cover modifications within the spirit and scope of the present disclosure as defined by the appended claims.

What is claimed is:

1. A system comprising:
a processing circuit comprising one or more memory devices coupled to one or more processors, the one or more memory devices configured to store instructions that, when executed by the one or more processors, cause the processing circuit to:
receive an image of a label
detect one or more physical characteristics of the label;
determine one or more colors of the label;
determine a data identifier for the one or more colors of the label;
determine a product identifier associated with the label based on the data identifier; and
generate a signal indicative of the product identifier.

2. The system of claim 1, wherein the instructions further cause the processing circuit to refine the image of the label based on the one or more physical characteristics of the label.

3. The system of claim 2, wherein refining the image of the label comprises at least one of sharpening the image, filtering out noise by median filtering, and applying an adaptive threshold to covert the image to black and white.

4. The system of claim 1, wherein the one or more physical characteristics of the label include at least one of a shape of the label and a size ratio of the label.

5. The system of claim 1, wherein the product identifier includes at least one of a stock keeping unit or a universal product code.

6. The system of claim 1, wherein the data identifier for the one or more colors includes at least one of a hexadecimal code or a RGB code.

7. The system of claim 1, wherein determining the one or more colors of the label further comprises:
selecting a sample set of neighboring pixels within the label;
determining a color identifier of each pixel within the sample set of neighboring pixels;
determining a majority value of pixels which have the color identifier in common; and
determining the one or more colors of the label based on the color identifier of the majority value of the pixels.

8. The system of claim 7, wherein determining the one or more colors of the label based on the color identifier of the majority value of the pixels further comprises utilizing one or more parity bits to detect an error when determining the one or more colors of the label.

9. The system of claim 1, wherein a fiducial label is used to determine the data identifier for the one or more colors of the label.

10. A method comprising:
receiving, by a processor, an image of a label
detecting, by the processor, one or more physical characteristics of the label;
determining, by the processor, one or more colors of the label;
determining, by the processor, a data identifier for the one or more colors of the label;
determining, by the processor, a product identifier associated with the label based on the data identifier; and
generating, by the processor, a signal indicative of a product corresponding to the product identifier.

11. The method of claim 10, wherein the method further includes refining the image of the label based on the one or more physical characteristics of the label.

12. The method of claim 11, wherein refining the image of the label comprises at least one of sharpening the image, filtering out noise by median filtering, and applying an adaptive threshold to covert the image to black and white.

13. The method of claim 10, wherein the one or more physical characteristics of the label include at least one of a shape of the label and a size ratio of the label.

14. The method of claim 10, wherein the product identifier includes at least one of a stock keeping unit or a universal product code.

15. The method of claim 10, wherein the data identifier for the one or more colors includes at least one of a hexadecimal code or a RGB code.

16. The method of claim 10, wherein determining the one or more colors of the label further comprises:
selecting, by the processor, a sample set of neighboring pixels within the label;
determining, by the processor, a color identifier of each pixel within the sample set of neighboring pixels;
determining, by the processor, a majority value of the pixels which have the color identifier in common; and
determining, by the processor, the one or more colors of the label based on the color identifier of the majority value of pixels.

17. The method of claim 10, wherein a fiducial label is used to determine the data identifier for the one or more colors of the label.

18. The method of claim 10, wherein the method further comprises utilizing one or more parity bits to detect an error when determining the one or more colors of the label.

19. A system comprising:
a processing circuit comprising one or more memory devices coupled to one or more processors, the one or more memory devices configured to store instructions that, when executed by the one or more processors, cause the processing circuit to:
receive an image of one or more labels within an aisle;
determine a coordinate location for each of the one or more labels in the image;
receive a video of the aisle;
compare the image of the one or more labels within the aisle with the video of the aisle to determine a highest value of feature matching;
determine a transformed coordinate location for each of the one or more labels based on the comparison of the image of the one or more labels within the aisle with the video of the aisle; and
determine a location for each of the one or more labels in the aisle based on the transformed coordinate location.

20. The system of claim 19, wherein the one or more processors creates a label map model displaying the coordinate location of each of the one or more labels relative to each other.
